(19) United States
(12) Patent Application Publication
(10) Pub. No.: US 2024/0261734 A1
(43) Pub. Date: Aug. 8, 2024

(54) MEMBRANE FILTERS FOR WATER AND WASTEWATER TREATMENT AND METHOD OF PRODUCING THE SAME

(71) Applicant: KYUNGPOOK NATIONAL UNIVERSITY INDUSTRY - ACADEMIC COOPERATION FOUNDATION), Daegu (KR)

(72) Inventors: Kwang Ho CHOO, Daegu (KR); Syed Salman Ali SHAH, Daegu (KR)

(21) Appl. No.: 18/565,354

(22) PCT Filed: May 31, 2022
(86) PCT No.: PCT/KR2022/007792

§ 371 Date: Nov. 29, 2023

(30) Foreign Application Priority Data
May 31, 2021 (KR) 10-2021-0069897

(51) Int. Cl. B01D 65/08; B01D 67/00; B01D 69/02; C02F 1/44; C02F 3/12; C02F 3/34

(52) U.S. Cl. CPC B01D 65/08; B01D 67/00931; B01D 67/00933; B01D 69/02; C02F 1/44; C02F 3/1268; C02F 3/34; B01D 2321/28; B01D 2323/02; B01D 2323/12; B01D 2323/30; B01D 2325/20; B01D 2325/36

(57) ABSTRACT

The present disclosure relates to a membrane filter for water and wastewater treatment including a membrane filter, hydrophilic polymers formed on the membrane filter; and quorum quenching microorganisms cross-linked with the membrane filter by the hydrophilic polymer. The quorum quenching microorganisms are attached to the surface of the membrane filter for water and wastewater treatment, resulting in a higher initial permeation pressure than a conventional membrane, but the quorum quenching microorganisms may effectively prevent the phenomenon of quorum sensing, allowing the formation of a biofilm, thereby improving the life of the membrane filter for water and wastewater treatment.

### TECHNICAL FIELD

The present description relates to membrane filters for water and wastewater treatment and a method of producing the same. Specifically, it relates to membrane filters that use hydrophilic polymers to form quorum quenching microorganisms on the membrane filters to degrade signal molecules of microorganisms in water, thereby efficiently preventing the formation of a biofilm on the membrane filters.

### BACKGROUND ART

In recent years, the membrane bioreactor process, which combines a biological water treatment reactor (bioreactor) with a membrane separation process as an alternative to conventional physicochemical or biological water treatment processes, has been actively studied and widely applied in practical processes.

The membrane bioreactor (MBR) process is a combination of the conventional activated sludge (CAS) method and the separation membrane process, maximizing the advantages of each. The MBR process, compared to the conventional CAS method, occupies a smaller footprint, operates stably under external shock loads, allows for the production of high-quality filtered water, and is easily automated, making it attractive for participation by multinational corporations and domestic major enterprises.

However, as the MBR process operates, microorganisms such as bacteria, fungi, and algae, existing inside the reactor initiate attached growth on the surface of the membrane filter, forming a biofilm with a thickness of tens of micrometers, covering the surface, leading to the issue of membrane fouling. The biofilm worsens the economics of the membrane bioreactor process due to issues such as degrading the filtration performance of the membrane filter, increasing energy consumption, and reducing the amount of water filtered or reducing cleaning cycles and lifetime of the membrane filter.

To solve such issues, various physical and chemical methods have been studied. Representative physical methods for reducing biofilm on the surface of a membrane filter include methods such as inducing biofilm detachment by increasing shear force through air scouring and biofilm detachment through backwashing. Chemical methods include injection of polymer coagulants to increase particle size or modification to increase the hydrophilicity of the surface of the membrane filter.

However, these studies have not yet provided satisfactory solutions at a level that meets the characteristics of wastewater treatment processes, where moisture and nutrients essential for microbial growth are ubiquitous, and where wastewater flows in the direction of membrane filtration, and due to the inherent resilience of the biofilm itself, once formed, it exhibits high resistance to external physical and chemical impacts. Therefore, a fundamental understanding of microbial characteristics and the development of biological approaches based on this understanding are crucial for the comprehensive resolution of biofilm fouling phenomena.

Microorganisms respond to changes in their environment, such as temperature, pH, and nutrients, by synthesizing specific signaling molecules and releasing/absorbing them into the extracellular space. When the concentration of these signal molecules reaches a certain level due to an increase in cell density, the expression of certain genes is triggered, resulting in the regulation of group behavior, a phenomenon known as quorum sensing, which typically occurs in environments with high cell density. This quorum sensing allows microorganisms to exhibit group behaviors, such as virulence, biofilm formation, conjugation, and sporulation.

The method of quorum quenching is gaining attention as the most efficient way to identify and solve the fundamental causes of biofilm contamination by inhibiting microorganism signaling substances, blocking the formation of communities (microbial layers), which are the main causes of biofilm contamination.

Korean Patent Publication No. 10-2020-0027381 aims to increase the growth and activity of quorum quenching microorganisms by including biostimulating substances in the inner layer, and there is an issue that the role of the carrier for microorganisms to proliferate and grow well is improved since a large amount of quorum quenching microorganisms are generated on the carrier, but the function of the membrane filter itself is not improved.

### DISCLOSURE

### Technical Problem

The present disclosure relates to a membrane filter for water and wastewater treatment to solve the issues of the prior art, and aims to form quorum quenching microorganisms on the membrane filter using hydrophilic polymers, which can effectively prevent biofilm formation on the membrane filter by degrading signal molecule substances of microorganisms in water.

### Solution to Problem

A membrane filter for water and wastewater treatment of the present disclosure to achieve the above-described technical problem includes: a membrane filter; hydrophilic polymers formed on the membrane filter; and quorum quenching microorganisms cross-linked with the membrane filter by the hydrophilic polymer.

The quorum quenching microorganism may include one or more selected from a group of Rhodococcus sp. BH4, Acinetobacter sp. DKY-1, Pseudomonas sp. Li4-2, Pseudomonas sp. 1A1, Pseudomonas sp. KS2, Pseudomonas sp. KS10, Bacillus methylotrophicus, Bacillus amyloliquefaciens, Candida albicans, Arthrobacter sp. MP1-2, Delftia sp. Le2-5, and Ralstonia sp. XJ12B, but is not limited thereto.

The hydrophilic polymer may include one or more selected from a group of polyvinyl alcohol, polyethylene glycol, polyacrylic acid, polyvidone, polyamine, chitosan, and alginic acid, but is not limited thereto.

A surface of the membrane filter for water and wastewater treatment may be coated with glycerol, but is not limited thereto.

A volume of the quorum quenching microorganism attached per unit surface area of the membrane filter for water and wastewater treatment is in a range of 0.001 μm³/μm² to 0.008 μm³/μm², but is not limited thereto.

A water permeability of the membrane filter for water and wastewater treatment is in a range of 1 L/m²-h-bar to 600 L/m²-h-bar.

A method of producing a membrane filter for water and wastewater treatment includes impregnating a membrane filter in a solution containing quorum quenching microorganisms and hydrophilic polymers. The quorum quenching microorganism is formed by being cross-linked with the membrane filter by the hydrophilic polymer.

The quorum quenching microorganism may include one or more selected from a group of Rhodococcus sp. BH4, Acinetobacter sp. DKY-1, Pseudomonas sp. Li4-2, Pseudomonas sp. 1A1, Pseudomonas sp. KS2, Pseudomonas sp. KS10, Bacillus methylotrophicus, Bacillus amyloliquefaciens, Candida albicans, Arthrobacter sp. MP1-2, Delftia sp. Le2-5, and Ralstonia sp. XJ12B.

The hydrophilic polymer may include one or more selected from a group of polyvinyl alcohol, polyethylene glycol, polyacrylic acid, polyvidone, polyamine, chitosan, and alginic acid, but is not limited thereto.

With respect to 100 parts by weight of the solution, 0.1 to 5 parts by weight of the quorum quenching microorganism and 0.5 to 5 parts by weight of the hydrophilic polymer may be included, but is not limited thereto.

A method of controlling biological contamination includes using the membrane filter for water and wastewater treatment.

The method may be applicable in the field of membrane bioreactors, advanced wastewater treatment, and desalination, but is not limited thereto.

The above-described means of solving the problem are merely exemplary and should not be interpreted as an intention to limit the present disclosure. In addition to the above-described exemplary embodiments, additional embodiments may exist in the drawings and detailed descriptions of the present disclosure.

### Effects of Invention

The disclosed technology may have the following effects. However, since it does not mean that a specific embodiment should include all of the following effects or only the following effects, the scope of the rights of the disclosed technology should not be understood as being limited thereto.

According to the means for solving the problems of the present disclosure, quorum quenching microorganism is attached to the membrane filter for water and wastewater treatment, and thus its initial water permeability may be lower than that of the conventional membrane filter. However, the quorum quenching microorganism may effectively prevent quorum sensing, thereby delaying the formation of a biofilm. Accordingly, when water treatment is conducted, it is more than twice as slow compared to the speed at which the conventional membrane filter is contaminated, so when applied to a biological reactor that treats wastewater, an excellent membrane pollution delay effect can be confirmed. In addition, it can be widely used in many industrial fields to control biological pollution (mechanical, marine, medical, etc.) and general living environments.

In addition, it can be manufactured with a general membrane filter sold for commercial use, which is excellent in compatibility and simple to apply, thereby simplifying the process and reducing costs.

### BRIEF DESCRIPTION OF DRAWINGS

(a) of FIG. 1 illustrates a Field-emission scanning electron microscope (FE-SEM) image of membrane filters for water and wastewater treatment produced in Embodiment 1, and (b) of FIG. 1 illustrates a confocal laser scanning microscope (CLSM) image of the membrane filters for water and wastewater treatment produced in Embodiment 1.

(a) of FIG. 2 illustrates an FE-SEM image of membrane filters for water and wastewater treatment produced in Comparative Example 5, and (b) of FIG. 2 illustrates a CLSM image of the membrane filters for water and wastewater treatment produced in Comparative Example 5.

(a) of FIG. 3 illustrates an FE-SEM image of membrane filters for water and wastewater treatment produced in Comparative Example 6, and (b) of FIG. 3 illustrates a CLSM image of the membrane filters for water and wastewater treatment produced in Comparative Example 6.

FIG. 4 illustrates a graph of the water permeability of the membrane filters for water and wastewater treatment produced in Embodiment 1, and Comparative Examples 5 and 6.

FIG. 5 illustrates a Fourier-transform infrared spectroscopy (FT-IR) graph of membrane filters for water and wastewater treatment produced in Embodiment 1, and Comparative Examples 1 and 2.

FIG. 6 illustrates a FT-IR graph of membrane filters for water and wastewater treatment produced in Embodiment 2, and Comparative Examples 3 and 4.

FIG. 7A illustrates an FE-SEM image of Comparative Example 1, FIG. 7B illustrates a FE-SEM image of Comparative Example 2, FIGS. 7C and 7D illustrate FE-SEM images of Embodiment 1.

FIG. 8A illustrates an FE-SEM image of Comparative Example 3, FIG. 8B illustrates a FE-SEM image of Comparative Example 4, and FIGS. 8C and 8D illustrate FE-SEM images of Embodiment 2.

(a) of FIG. 9 illustrates a CLSM image of Comparative Example 1, (b) illustrates a CLSM image of Comparative Example 2, and (c) illustrates a CLSM image of Embodiment 1.

(a) of FIG. 10 illustrates a CLSM image of Comparative Example 3, (b) illustrates a CLSM image of Comparative Example 4, and (c) illustrates a CLSM image of Embodiment 2.

FIG. 11 illustrates a graph showing the biovolume of quorum quenching microorganisms shown in Embodiment 1 and Embodiment 2 shown in FIG. 10.

(a) of FIG. 12 illustrates a photograph of the bioassay conducted in Comparative Example 1, (b) illustrates a photograph of the bioassay conducted in Comparative Example 2, and (c) illustrates a photograph of the bioassay conducted in Embodiment 1.

(a) of FIG. 13 illustrates a photograph of the bioassay conducted in Comparative Example 3, (b) illustrates a photograph of the bioassay conducted in Comparative Example 4, and (c) illustrates a photograph of the bioassay conducted in Embodiment 2.

FIG. 14 illustrates a graph showing the degradation of C8-HSL in the bioassays of Embodiment 1, Comparative Example 1, and Comparative Example 2.

FIG. 15 illustrates a graph showing the degradation of C8-HSL in the bioassays of Embodiment 2, Comparative Example 3, and Comparative Example 4.

(a) of FIG. 16 illustrates a CLSM image when forming a biofilm of PAO1 in Comparative Example 1, (b) illustrates a CLSM image for Comparative Example 2, and (c) illustrates an image for Embodiment 1.

(a) of FIG. 17 illustrates a CLSM image when forming a biofilm of PAO1 in Comparative Example 3, (b) illustrates a CLSM image in Comparative Example 4, and (c) illustrates a CLSM image in Embodiment 2.

(a) of FIG. 18 illustrates a graph indicating the quantity of microorganisms from FIG. 16, and (b) illustrates a graph indicating the quantity of microorganisms from FIG. 17.

FIG. 19 illustrates a graph showing the water permeability of Embodiments 1 and 2 and Comparative Examples 1 to 4.

FIG. 20 illustrates a graph of transmembrane pressure (TMP) for the membrane filters for water and wastewater treatment in Embodiment 1, Comparative Example 1, and Comparative Example 2 when a constant flux level of 15 L/m²-h is applied.

FIG. 21 illustrates a graph of TMP for the membrane filters for water and wastewater treatment in Embodiment 2, Comparative Example 3, and Comparative Example 4 when a constant flux level of 15 L/m²-h, 20 L/m²-h, and 25 L/m²-h is applied.

FIG. 22 illustrates a graph of the biofouling rates of Embodiments 1 and 2, and Comparative Examples 1 to 4.

FIG. 23 illustrates a graph showing the coverage rate of hydrophilic polymers and quorum quenching microorganisms on the membrane filters for water and wastewater treatment produced in Embodiments 1 and 2, Comparative Example 2, and Comparative Example 4.

### BEST MODE FOR CARRYING OUT THE INVENTION

Since the present disclosure may be modified in various ways and may have various embodiments, specific embodiments will be illustrated in the drawings and described in detail in the detailed description. However, this is not intended to limit the present disclosure to specific embodiments, and should be understood to include all changes, equivalents, and substitutes included in the spirit and technical scope of the present disclosure.

When describing each drawing, similar reference signs are used for similar components. Terms such as first, second, etc. may be used to describe various components, but the components should not be limited by such terms. The terms are used only to distinguish one component from another.

For example, without departing from the scope of the present disclosure, a first component may be named as a second component, and similarly, a second component may be named as a first component. The term “and/or” includes a combination of a plurality of related recited items or any one of a plurality of related recited items.

Unless otherwise defined, all terms used herein, including technical or scientific terms, shall have the same meaning as commonly understood by one of ordinary skill in the art to which this disclosure belongs.

Terms, such as defined in commonly used dictionaries, are to be construed to have a meaning consistent with the meaning they have in the context of the relevant art and are not construed in an idealized or overly formal sense unless expressly defined in this application.

Throughout the present specification, when a member is said to be “on,” “above,” “over,” “under,” “below,” or “at the bottom” of another member, this includes not only when a member is tangential to another member, but also when there is another member between the two members.

Throughout the present specification, when a part is said to “include” a certain element, this means that it may further include other elements rather than excluding other elements, unless specifically stated to the contrary.

As used herein, the terms “about,” “substantially,” etc. are intended to mean at or near the numerical value when manufacturing and material tolerances inherent in the recited values are given, and are used for the purpose of clarity and to prevent unscrupulous infringers from taking unfair advantages of the disclosure where precise or absolute numerical values are recited. In addition, throughout the specification, the term “a step that” or “a step of” does not mean “a step for.”

Throughout the present specification, the term “combination thereof” included in the Markush expression refers to a mixture or combination of one or more components selected from the group consisting of the components described in the Markush expression, including one or more selected from the group of components.

Hereinafter, the present membrane filters for water and wastewater treatment and the manufacturing thereof will be described in detail with reference to embodiments, examples, and drawings. However, the present disclosure is not limited to these embodiments, examples, and drawings.

The present disclosure relates to a membrane filter for water and wastewater treatment, including a membrane filter; hydrophilic polymers formed on the membrane filter; and quorum quenching microorganisms cross-linked with the membrane filter by the hydrophilic polymers.

By using the membrane filter according to the present disclosure, the formation of quorum sensing may be effectively suppressed.

Since it can be produced with a general membrane filter sold for commercial use, it is easy to simplify the process and reduce costs due to its excellent compatibility and simple application method.

Quorum quenching microorganisms are attached to the membrane filter for water and wastewater treatment according to the present disclosure, and thus its initial water permeability may be lower than that of the conventional membrane filter. However, the quorum quenching microorganism may effectively prevent quorum sensing, thereby delaying the formation of a biofilm. Accordingly, when water treatment is conducted, it is more than twice as slow compared to the speed at which the conventional membrane filter is contaminated, so when applied to a biological reactor that treats wastewater, an excellent membrane fouling delay effect can be confirmed. In addition, it can be widely used in many industrial fields to control biological fouling (mechanical, marine, medical, etc.) and general living environments.

In the present disclosure, any quorum quenching microorganism is suitable as long as it can produce enzymes that inhibit biofilm formation or produce quorum sensing inhibiting enzymes that degrade signal molecules or signal transmitters used in quorum-sensing mechanisms.

The quorum quenching microorganism may include one or more selected from a group of Rhodococcus sp. BH4, Acinetobacter sp. DKY-1, Pseudomonas, such as Pseudomonas sp. Li4-2, Pseudomonas sp. 1A1, Pseudomonas sp. KS2, and Pseudomonas sp. KS10, Bacillus, such as Bacillus methylotrophicus, and Bacillus amyloliquefaciens, Candida albicans, Arthrobacter sp. MP1-2, Delftia sp. Le2-5, and Ralstonia sp. XJ12B, but is not limited there to.

The Rhodococcus sp. BH4 may inhibit biofilm formation by microorganism by neutralizing signaling through the enzymatic degradation of acyl homoserine lactone (AHL), one of the signal transmitters used in quorum sensing mechanisms.

The Acinetobacter sp. DKY-1 is known to interfere with quorum mechanism by generating a chemical that degrades type 2 signal transmitter (i.e., autoinducer-2) that is used to detect quorum sensing between microbial species and releasing it extracellularly.

The hydrophilic polymer may include one or more selected from a group of polyvinyl alcohol, polyethylene glycol, polyacrylic acid, polyvidone, polyamine, chitosan, and alginic acid, but is not limited thereto.

The hydrophilic polymer cross-links the quorum quenching microorganism with the surface of the membrane filter so that the quorum quenching microorganism can be effectively attached to the surface of the membrane filter.

The surface of the membrane filter for water and wastewater treatment may be coated with glycerol, but is not limited thereto.

Since the surface of the membrane filter for water and wastewater treatment is further coated with glycerol, the quorum quenching microorganism may be protected from external factors.

The coverage rate of the hydrophilic polymer on the surface of the membrane filter for water and wastewater treatment is between 30% and 80%, and the coverage rate in cases where quorum quenching microorganism coexist also range from 30% to 80%, but is not limited thereto.

The coverage rate refers to the proportion of adsorbent covering the surface in the adsorption process on the surface of the membrane filter for water and wastewater treatment. In other words, the coverage rate of the hydrophilic polymer refers to the proportion of the membrane filter's surface covered by the hydrophilic polymer, and the coverage rate in cases where quorum quenching microorganisms coexist refers to the proportion of the membrane filter's surface covered by both the hydrophilic polymer and the quorum quenching microorganism.

If the coverage rate of the hydrophilic polymer and quorum quenching microorganism on the surface of the membrane filter for water and wastewater treatment is less than 30%, the phenomenon of quorum sensing cannot be effectively inhibited. If the coverage rate of the hydrophilic polymer and quorum quenching microorganism is greater than 80%, the pores of the membrane filter are blocked, resulting in a lower water permeability and thus a decrease in its function as a membrane filter.

If the coverage rate of the hydrophilic polymer on the surface of the membrane filter for water and wastewater treatment is less than 30%, the quorum quenching microorganisms are not sufficiently attached to effectively inhibit the quorum sensing phenomenon. If the coverage rate of hydrophilic polymer is greater than 80%, the pores of the membrane filter are blocked, resulting in a lower water permeability and thus a decrease in its function as a membrane filter.

The amount (volume) of the quorum quenching microorganisms attached per unit surface area of the membrane filter for water and wastewater treatment is in a range of 0.001 μm³/μm² to 0.008 μm³/μm², but is not limited thereto.

If the amount (volume) of the quorum quenching microorganisms attached per unit surface area of the membrane filter for water and wastewater treatment is less than 0.001 μm³/μm², the quorum sensing phenomenon cannot be effectively inhibited. If the amount (volume) of the quorum quenching microorganisms is greater than 0.008 μm³/μm², the pores of the membrane filter are blocked, resulting in a lower water permeability and thus a decrease in its function as a membrane filter.

The water permeability of the membrane filter for water and wastewater treatment may be from 1 L/m²-h-bar to 600 L/m²-h-bar, but is not limited thereto. More preferably, the water permeability of the membrane filter for water and wastewater treatment may be from 30 L/m²-h-bar to 200 L/m²-h-bar.

If the water permeability of the membrane filter for water and wastewater treatment is less than 1 L/m²-h-bar, it may not be able to perform well as a low-pressure water treatment membrane. In addition, the water permeability of the membrane filter for water and wastewater treatment is greater than 600 L/m²-h-bar, it may indicate a low coverage rate of hydrophilic polymers or quorum quenching microorganisms.

The quorum quenching microorganism formed on the membrane filter may be alive, but is not limited thereto.

The quorum quenching microorganism, in a living state, is attached to the membrane filter, allowing it to effectively delay the formation of a biofilm by producing enzymes that inhibit biofilm formation or producing quorum sensing inhibiting enzymes that degrade signal molecules or signal transmitters used in quorum sensing mechanisms.

The present disclosure provides a method for producing a membrane filter for water and wastewater treatment, including impregnating a membrane filter in a solution containing quorum quenching microorganisms and hydrophilic polymers, wherein the quorum quenching microorganisms is cross-linked on the membrane filter by the hydrophilic polymers.

The detailed description of the method of producing a membrane filter for water and wastewater treatment has been omitted for the parts that overlap with the detailed description of the membrane filter for water and wastewater treatment, but even if the description is omitted, the contents described in the method of producing a membrane filter for water and wastewater treatment may be applied to the membrane filter for water and wastewater treatment.

The quorum quenching microorganism may include one or more selected from a group of Rhodococcus sp. BH4, Acinetobacter sp. DKY-1, Pseudomonas, such as Pseudomonas sp. Li4-2, Pseudomonas sp. 1A1, Pseudomonas sp. KS2, and Pseudomonas sp. KS10, Bacillus, such as Bacillus methylotrophicus, and Bacillus amyloliquefaciens, Candida albicans, Arthrobacter sp. MP1-2, Delftia sp. Le2-5, and Ralstonia sp. XJ12B but is not limited thereto.

The hydrophilic polymer may include one or more selected from a group of polyvinyl alcohol, polyethylene glycol, polyacrylic acid, polyvidone, polyamine, chitosan, and alginic acid, but is not limited thereto.

With respect to 100 parts by weight of the solution, 0.1 to 5 parts by weight of the quorum quenching microorganism and 0.5 to 5 parts by weight of the hydrophilic polymer may be included, but it is not limited thereto.

The impregnation may be performed for 3 hours to 12 hours, but is not limited thereto.

Another aspect of the present disclosure relates to a method of controlling biological contamination using the membrane filter for water and wastewater treatment.

The method of controlling biological fouling is applicable in the fields of membrane bioreactors, advanced wastewater treatment, and desalination. The method of controlling biological contamination in the present disclosure may be applied to all methods that can eliminate and treat pollution as environmental pollution by microorganisms and various organisms intensifies, and specifically may be applied to the field of membrane bioreactors, advanced wastewater treatment, desalination, and biofouling of pipes and facilities.

In the field of advanced wastewater treatment and desalination, advanced wastewater treatment refers to the process of eliminating pollutants from domestic or industrial wastewater, and it is employed to minimize environmental issues or enable the reuse of treated water. To treat wastewater, a series of processes, including primary, secondary, and tertiary treatments, are implemented. Advanced treatment, specifically referring to tertiary treatment, involves various facilities and processes, such as raid filtration, activated carbon, membrane separation, ozone oxidation facilities, chlorine injection, ion exchange, and phosphorus removal facilities, depending on the target substances for treatment.

Desalination is a series of water treatment processes that remove salts and other dissolved substances from seawater that cannot be used directly for domestic or industrial purposes to produce pure drinking, domestic, and industrial water.

### Mode for Carrying Out The Invention

The following embodiments will further describe the present disclosure, but the following embodiments are for illustrative purposes only and are not intended to limit the scope of the present disclosure.

### Embodiment 1

First, a dope solution was produced by dissolving 15 wt % polysulfone (PS) pellets and 20 wt % polyvinylpyrrolidone (PVP) to 65 wt % dimethylacetamide (DMA), stirring at 60° C. for 6 hours.

Subsequently, 70% v/v DMA in water was ready as a bore solution.

A PS membrane was obtained ejecting a hollow fiber membrane with the dope solution on the outer side and the bore solution on the inner side.

Subsequently, 2 wt % polyvinyl alcohol (PVA), 0.2 wt % sodium alginate were mixed with distilled water and then autoclaved for 15 minutes at 121° C. to prepare a polymer solution.

0.5 wt % BH4 was added to the polymer solution and stirred at room temperature for 30 minutes to produce a quorum quenching microbial solution.

The PS membrane was impregnated into the quorum quenching microbial solution for 6 hours to produce a membrane filter for water and wastewater treatment. Following this, it was further stabilized by immersing in 0.5 M Na₂SO₄ solution for 2 hours.

### Embodiment 2

First, 2 wt % polyvinyl alcohol (PVA), 0.2 wt % sodium alginate were mixed with distilled water and then autoclaved for 15 minutes at 121° C. to produce a polymer solution.

0.5 wt % BH4 was added to the polymer solution and stirred at room temperature for 30 minutes to prepare a quorum quenching microbial solution.

Subsequently, a polyvinylidene fluoride (PVDF) membrane filter (Cleanfil® S series) with a pore diameter of 0.1 μm was impregnated into the quorum quenching microbial solution for 6 hours to produce a membrane filter for water and wastewater treatment. Following this, it was further stabilized by immersing in 0.5 M Na₂SO₄ solution for 2 hours.

### Comparative Example 1

First, a dope solution was produced by dissolving 15 wt % polysulfone (PS) pellets and 20 wt % polyvinylpyrrolidone (PVP) to 65 wt % dimethylacetamide (DMA), stirring at 60° C. for 6 hours.

Subsequently, 70% v/v DMA in water was ready as a bore solution.

A PS membrane was obtained ejecting a hollow fiber membrane with the dope solution on the outer side and the bore solution on the inner side.

### Comparative Example 2

A membrane filter for water and wastewater treatment was produced by impregnating the PS membrane produced in Comparative Example 1 in the polymer solution produced in Embodiment 1 for 6 hours.

### Comparative Example 3

As Comparative Example 3, a polyvinylidene fluoride (PVDF) membrane filter (Cleanfil® S series) with a pore diameter of 0.1 μm was used.

### Comparative Example 4

A membrane filter for water and wastewater treatment was produced by impregnating the PVDF membrane used in Comparative Example 3, which was impregnated in the polymer solution produced in Embodiment 1 for 6 hours.

### Comparative Example 5

A membrane filter for water and wastewater treatment was obtained by ejecting the dope solution, bore solution, and 0.5 wt % BH4 solution produced in Embodiment 1.

### Comparative Example 6

A membrane filter for water and wastewater treatment was obtained by ejecting the dope solution, bore solution, and quorum quenching microbial solution produced in Embodiment 1.

### Evaluation

### 1. Characteristic Analysis of Membrane Filter for Water and Wastewater Treatment

Characteristics of the membrane filters for water and wastewater treatment produced in Embodiments 1 and 2 and Comparative Examples 1 to 6 were observed, and the results thereof are shown in FIG. 1 to FIG. 15.

(a) of FIG. 1 illustrates a Field-emission scanning electron microscope (FE-SEM) image of membrane filters for water and wastewater treatment produced in Embodiment 1, and (b) of FIG. 1 illustrates a confocal laser scanning microscope (CLSM) image of the membrane filters for water and wastewater treatment produced in Embodiment 1.

According to the results shown in FIG. 1, it can be seen that the quorum quenching microorganisms were formed on the membrane filter alive.

(a) of FIG. 2 illustrates an FE-SEM image of membrane filters for water and wastewater treatment produced in Comparative Example 5, and (b) of FIG. 2 illustrates a CLSM image of the membrane filters for water and wastewater treatment produced in Comparative Example 5.

According to the results shown in FIG. 2, it can be seen that the quorum quenching microorganisms are not formed on the membrane filter when the hydrophilic polymer solution is not added.

According to the results shown in FIGS. 1 and 2, it can be seen that the hydrophilic polymer performs crosslinking between the quorum quenching microorganisms and the membrane filter so that the quorum quenching microorganisms are attached to the membrane to be formed.

(a) of FIG. 3 illustrates an FE-SEM image of a membrane filter for water and wastewater treatment produced in Comparative Example 6, and (b) of FIG. 3 illustrates a CLSM image of the membrane filter for water and wastewater treatment produced in Comparative Example 6.

According to the results shown in FIG. 3, if a hydrophilic polymer solution and quorum quenching microorganisms are ejected while forming a membrane filter, a membrane filter to which a large amount of quorum quenching microorganisms are attached may be formed.

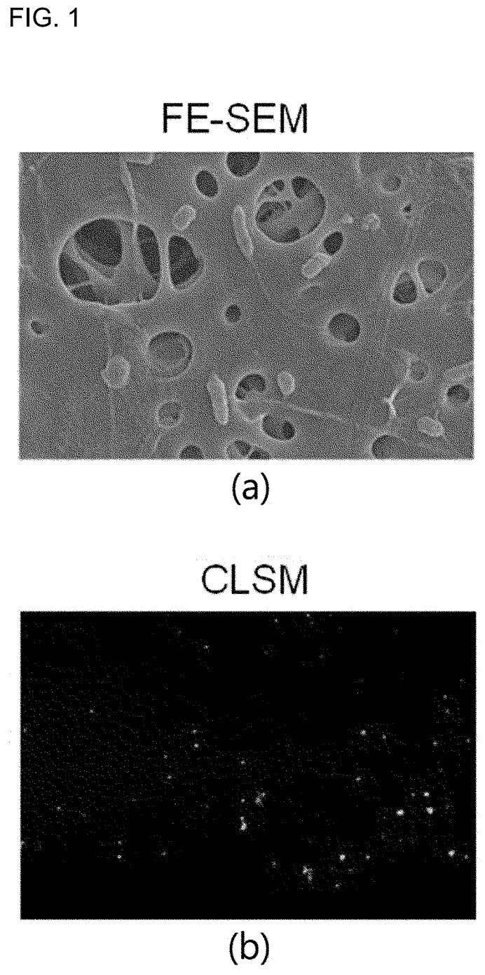

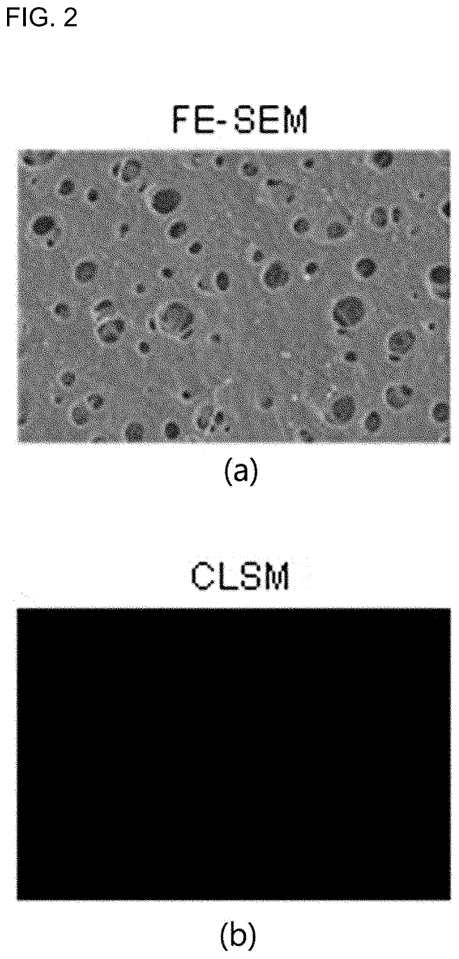

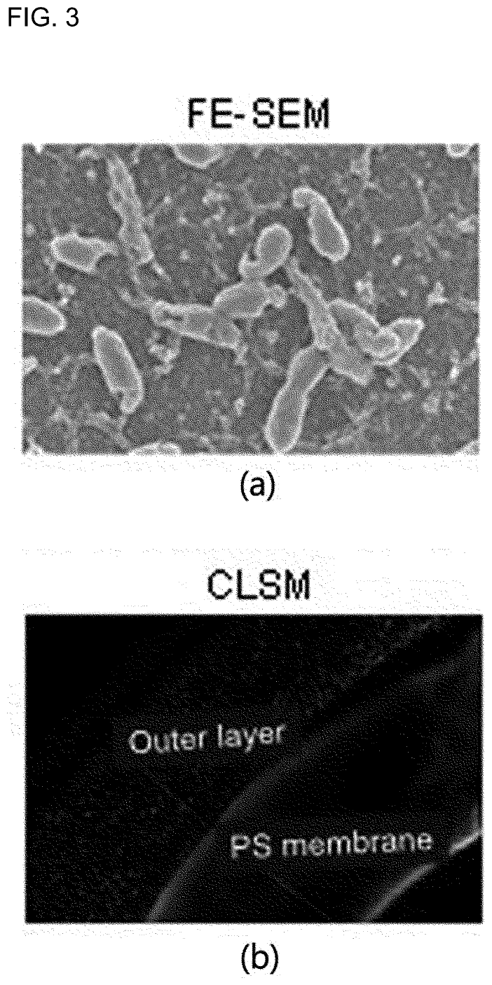

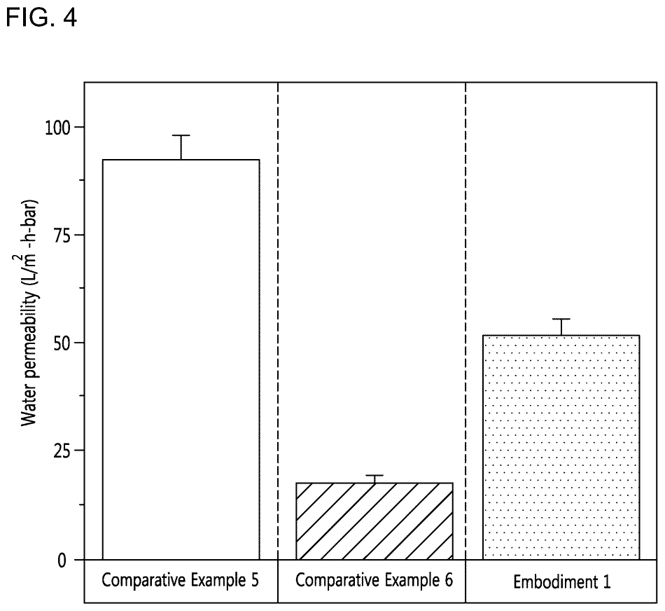

FIG. 4 illustrates a graph of the water permeability of the membrane filters for water and wastewater treatment produced in Embodiment 1, and Comparative Examples 5 and 6.

According to the result shown in FIG. 4, it can be seen that Comparative Example 5, where no quorum quenching microorganism is attached, has the highest water permeability. In addition, Comparative Example 6, where the most quorum quenching microorganisms are attached, has the lowest water permeability. Particularly, Comparative Example 6 has a water permeability lower than 25 L/m²-h-bar and cannot be used as a membrane filter. On the other hand, the water permeability of Embodiment 1 is found to be 50 L/m²-h-bar, which is lower than the water permeability of Comparative Example 5, but greater than 30 L/m²-h-bar, which is generally acceptable for use as a membrane filter. In other words, it can be expected that the membrane filter for water and wastewater treatment produced in Embodiment 1 has an appropriate water permeability for use as a membrane filter, while effectively inhibiting the formation of biofilms due to the attachment of quorum quenching microorganisms.

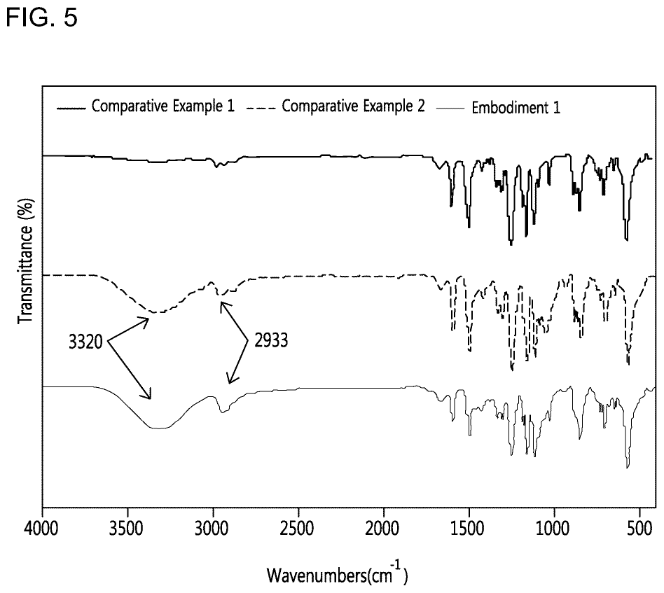

FIG. 5 illustrates a Fourier-transform infrared spectroscopy (FT-IR) graph of membrane filters for water and wastewater treatment produced in Embodiment 1, and Comparative Examples 1 and 2.

According to the results shown in FIG. 5, it can be seen that the peaks appearing in Comparative Example 2 (PS membrane+hydrophilic polymer) are not only the peaks appearing in Comparative Example 1 (PS membrane), but also the symmetrical stretching vibration peak of —OH around 3320 cm⁻¹ and the asymmetrical stretching vibration peak of —CH2 around 2933 cm⁻¹. It can also be seen that Embodiment 1 exhibits peaks similar to those in Comparative Example 2.

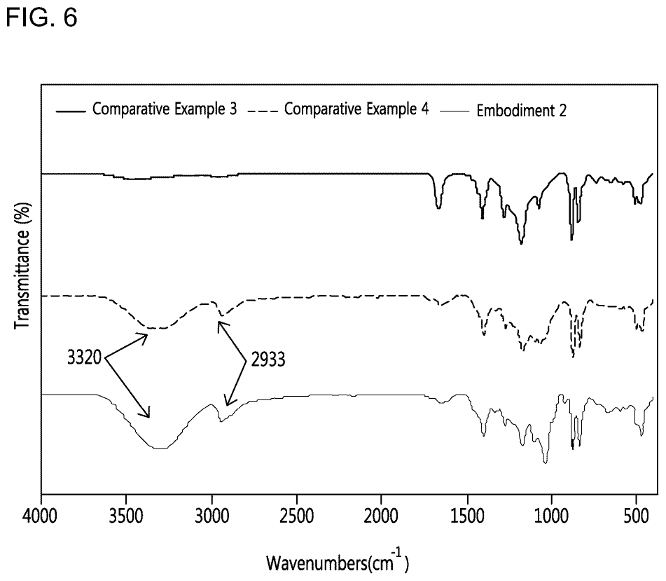

FIG. 6 illustrates a FT-IR graph of membrane filters for water and wastewater treatment produced in Embodiment 2, and Comparative Examples 3 and 4.

According to the results shown in FIG. 6, it can be seen that the peaks in Comparative Example 4 (PVDF membrane+hydrophilic polymer) are similar to those in Comparative Example 3 (PVDF membrane), as well as the symmetrical stretching vibration peak of —OH around 3320 cm⁻¹ and the asymmetrical stretching vibration peak of —CH2 around 2933 cm⁻¹. It can be seen that Embodiment 2 exhibits similar peaks as in Comparative Example 2.

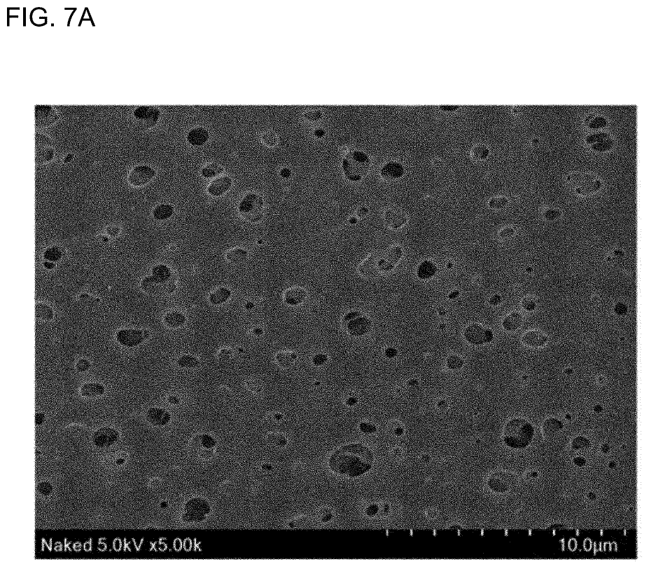

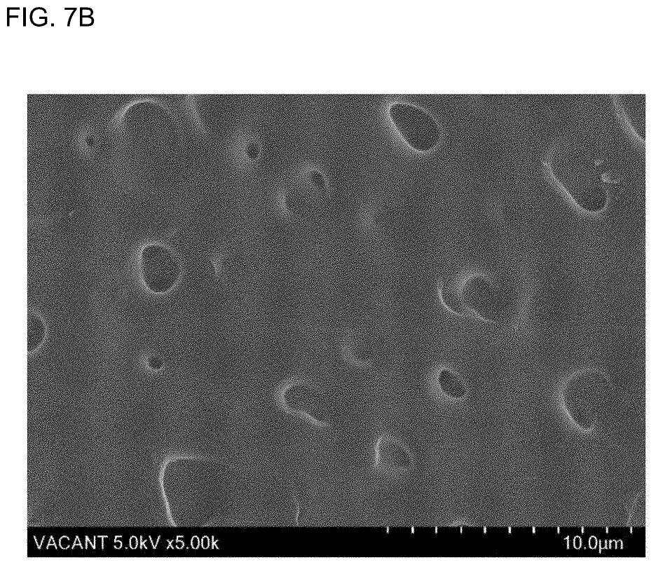

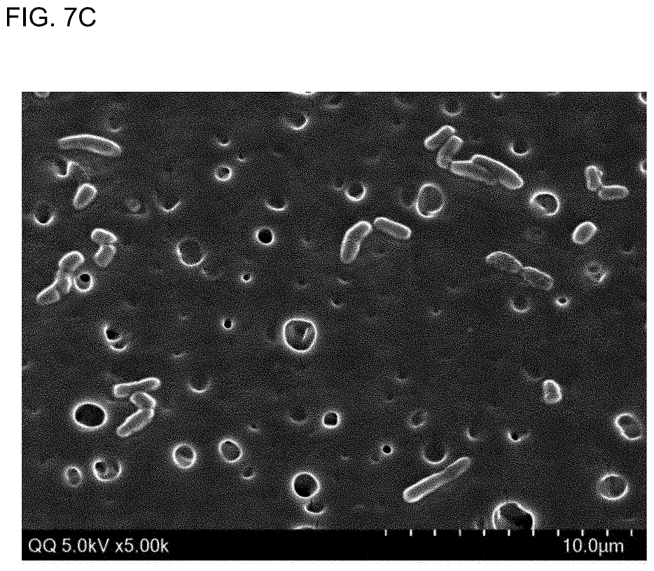

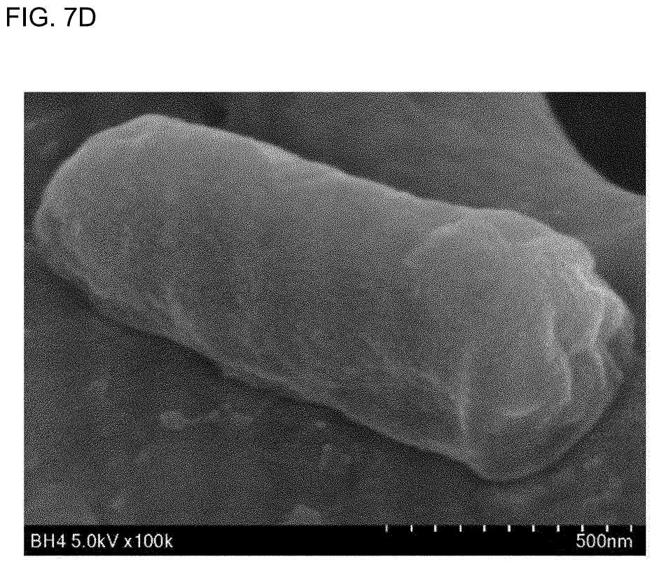

FIG. 7A illustrates an FE-SEM image of Comparative Example 1, FIG. 7B illustrates a FE-SEM image of Comparative Example 2, FIGS. 7C and 7D illustrate FE-SEM images of Embodiment 1.

In FIG. 5, it can be seen that Comparative Example 2 has hydrophilic groups attached to the PS membrane, but referring to FIG. 7B, it can be seen that the FE-SEM results do not show a significant difference. Furthermore, referring to FIGS. 7C and 7D, it can be seen that quorum quenching microorganisms are attached and formed on the membrane filter.

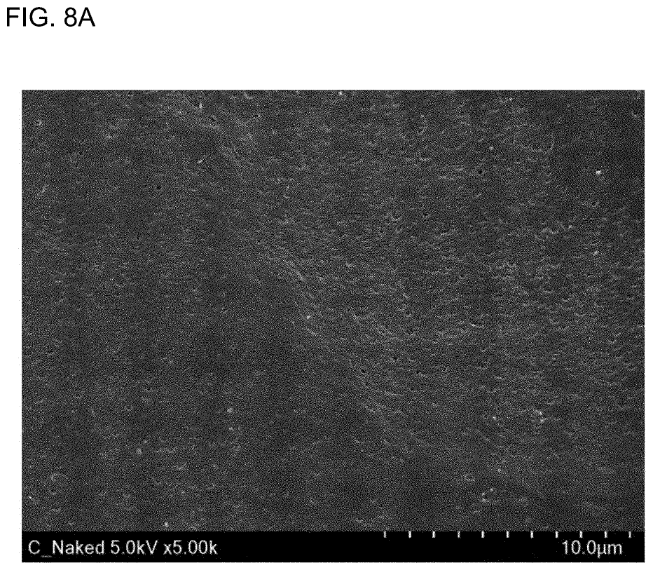

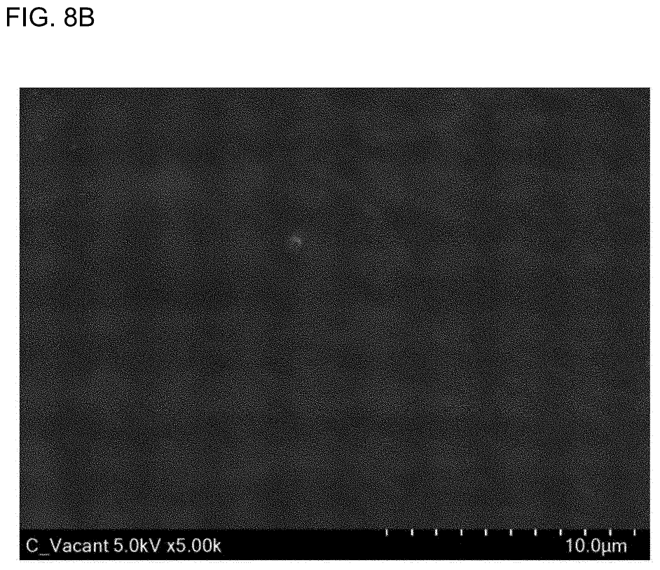

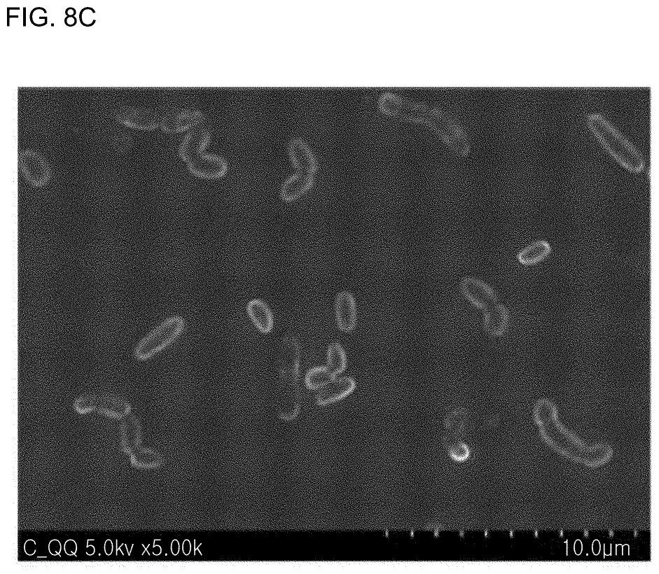

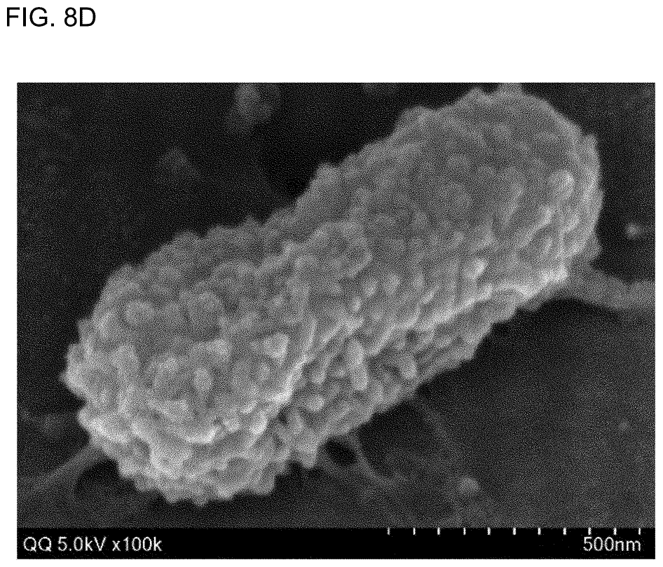

FIG. 8A illustrates a FE-SEM image of Comparative Example 3, FIG. 8B illustrates a FE-SEM image of Comparative Example 4, and FIGS. 8C and 8D illustrate FE-SEM images of Embodiment 2.

In FIG. 6, it can be seen that Comparative Example 4 has hydrophilic groups attached to the PVDF membrane, but referring to FIG. 8B, it can be seen that the FE-SEM results do not show a significant difference. In addition, referring to FIGS. 8C and 8D, it can be seen that quorum quenching microorganisms are attached and formed on the membrane filter.

(a) of FIG. 9 illustrates a CLSM image of Comparative Example 1, (b) illustrates a CLSM image of Comparative Example 2, and (c) illustrates a CLSM image of Embodiment 1.

According to the results shown in FIG. 9, it can be seen that no quorum quenching microorganisms are found in Comparative Examples 1 and 2, whereas in Embodiment 1, quorum quenching microorganisms are found alive.

(a) of FIG. 10 illustrates a CLSM image of Comparative Example 3, (b) illustrates a CLSM image of Comparative Example 4, and (c) illustrates a CLSM image of Embodiment 2.

According to the results shown in FIG. 10, it can be seen that no quorum quenching microorganisms are found in Comparative Examples 3 and 4, whereas in Embodiment 2, quorum quenching microorganisms are found alive.

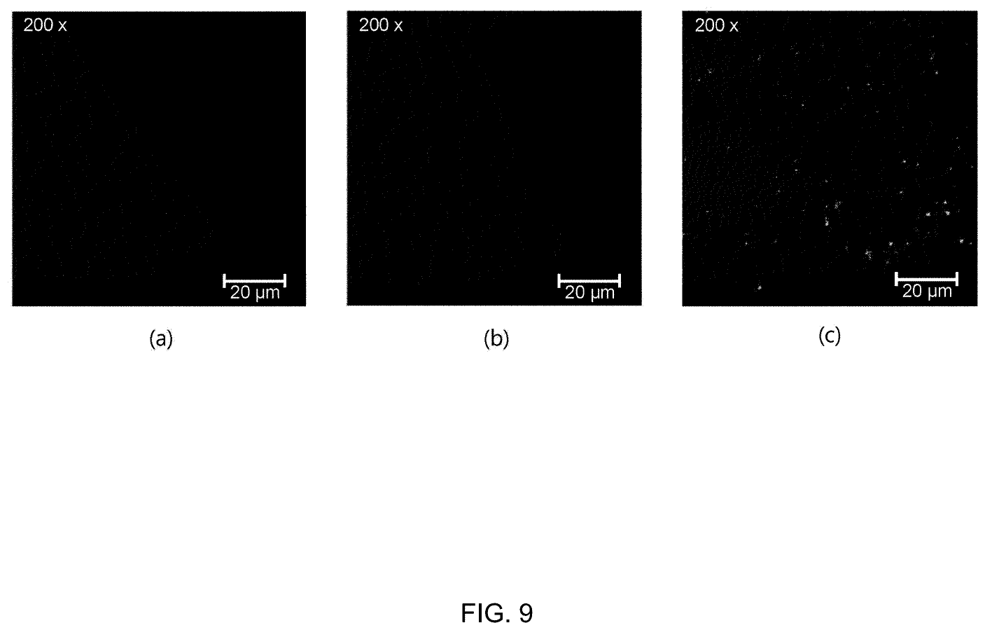

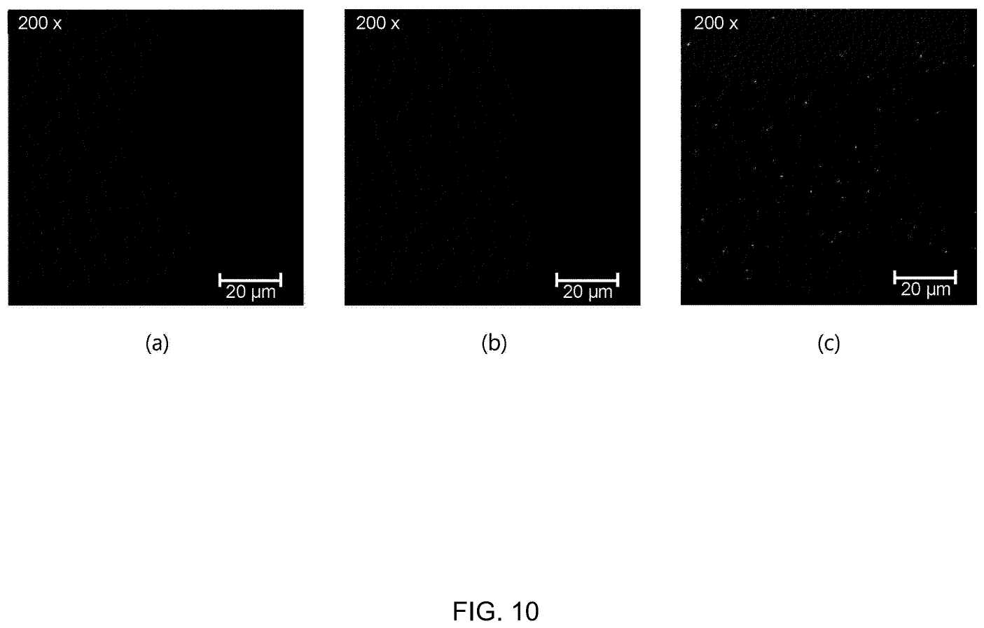

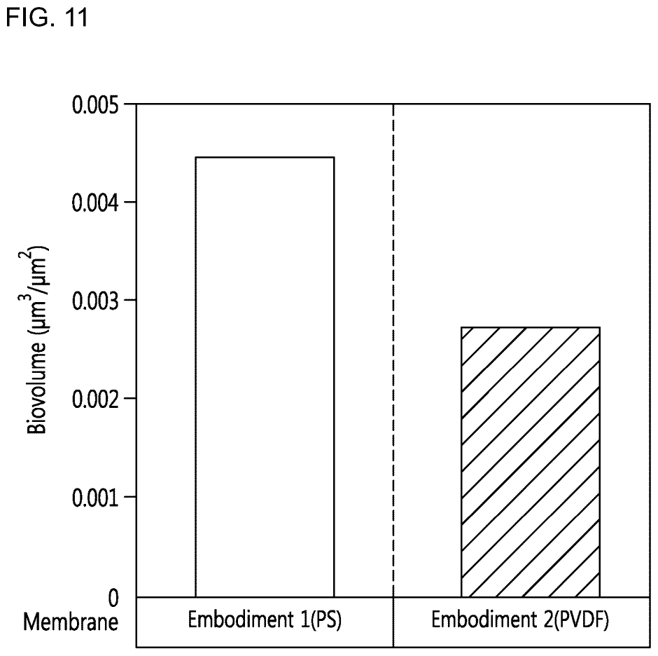

FIG. 11 illustrates a graph showing the biovolume of quorum quenching microorganisms shown of Embodiment 1 and Embodiment 2 shown in FIG. 10.

According to the results shown in FIG. 11, Embodiment 1 is 0.0044 μm³/μm², and Embodiment 2 is 0.0027 μm³/μm².

According to the results shown in FIGS. 5 to 11, it can be seen that the hydrophilic polymer allows quorum quenching microorganisms to attach to the membrane through cross-linking.

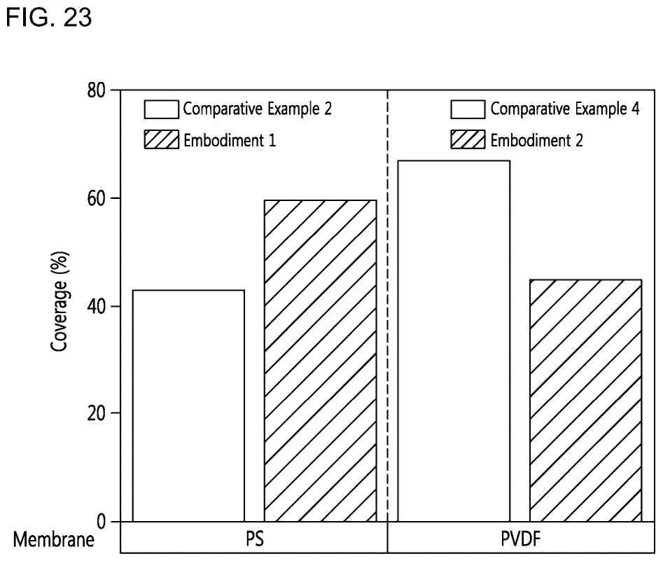

FIG. 23 illustrates a graph showing the coverage rate of hydrophilic polymers and quorum quenching microorganisms on the membrane filters for water and wastewater treatment produced in Embodiments 1 and 2, Comparative Example 2, and Comparative Example 4.

According to the results shown in FIG. 23, the coverage rate of PS in Comparative Example 2 is about 40%, and the coverage rate of PVDF in Comparative Example 4 is about 60%. Furthermore, in Embodiment 1, the coverage rate in the coexistence of a hydrophilic polymer and quorum quenching microorganism is about 60%, while in Embodiment 2, the coverage rate in the coexistence of a hydrophilic polymer and quorum quenching microorganism is about 40%. It can be expected that the coverage range of the membrane filter depends on the material of the membrane filter.

A bioassay was performed to determine the bioactivity of quorum quenching microorganisms attached to the membrane filter. Specifically, the bioassay was performed using Lauria-Bertani (LB) agar plates containing C8-HSL(N-octanoyl-L-homoserine lactone) and A136, and the results are shown in FIGS. 12 to 15.

(a) of FIG. 12 illustrates a photograph of the bioassay conducted in Comparative Example 1, (b) illustrates a photograph of the bioassay conducted in Comparative Example 2, and (c) illustrates a photograph of the bioassay conducted in Embodiment 1.

According to the results shown in FIG. 12, it can be seen that Comparative Examples 1 and 2 do not show bioactivity, whereas Embodiment 1 shows bioactivity.

(a) of FIG. 13 illustrates a photograph of the bioassay conducted in Comparative Example 3, (b) illustrates a photograph of the bioassay conducted in Comparative Example 4, and (c) illustrates a photograph of the bioassay conducted in Embodiment 2.

According to the results shown in FIG. 13, it can be seen that Comparative Examples 3 and 4 do not show bioactivity, whereas Embodiment 2 shows bioactivity.

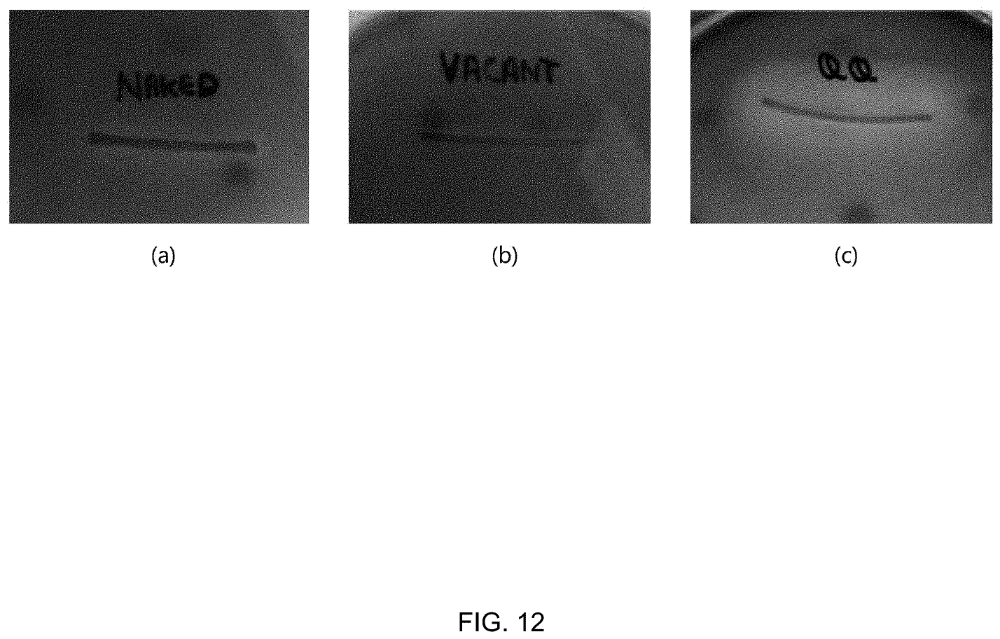

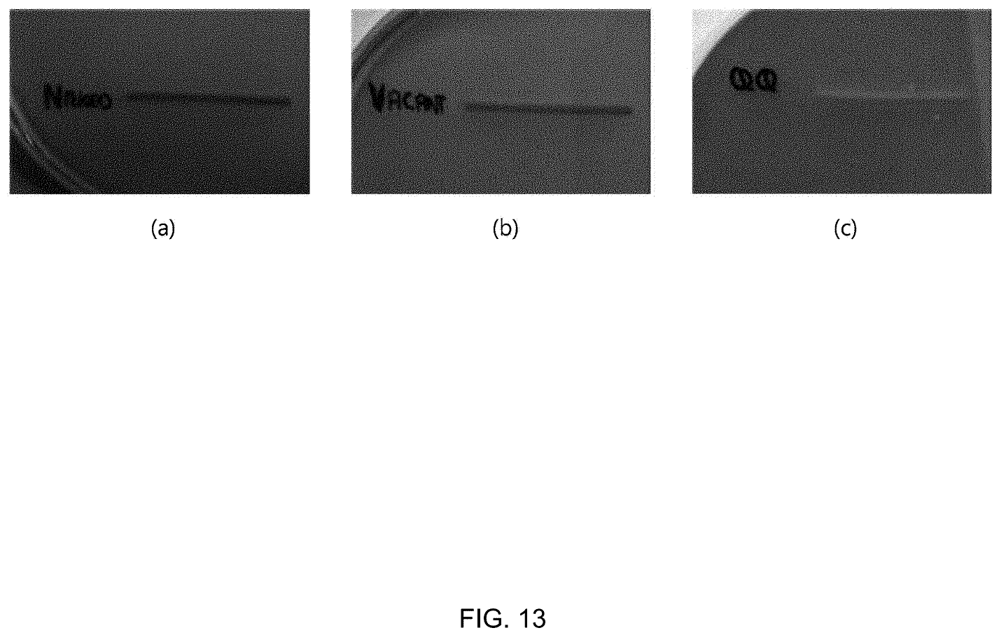

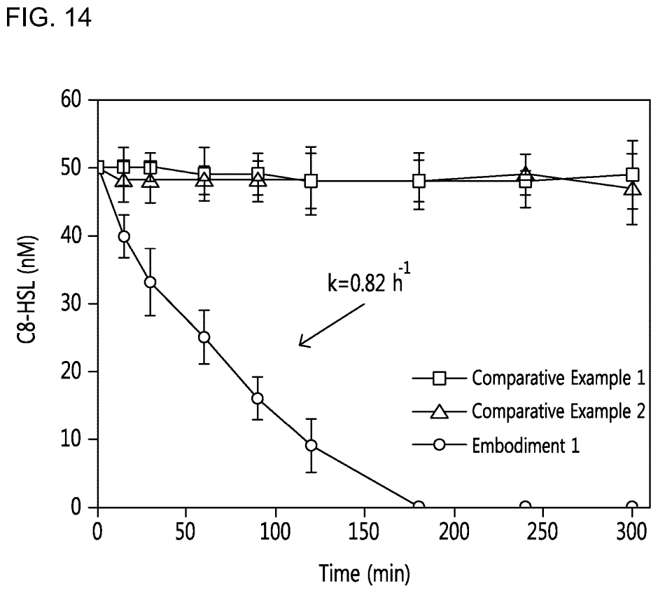

FIG. 14 illustrates a graph showing the degradation of C8-HSL in the bioassays of Embodiment 1, Comparative Example 1, and Comparative Example 2.

According to the results shown in FIG. 14, it can be seen that Comparative Examples 1 and 2 do not show degradation of C8-HSL, while Embodiment 1 shows degradation with a constant of 0.82 h⁻¹.

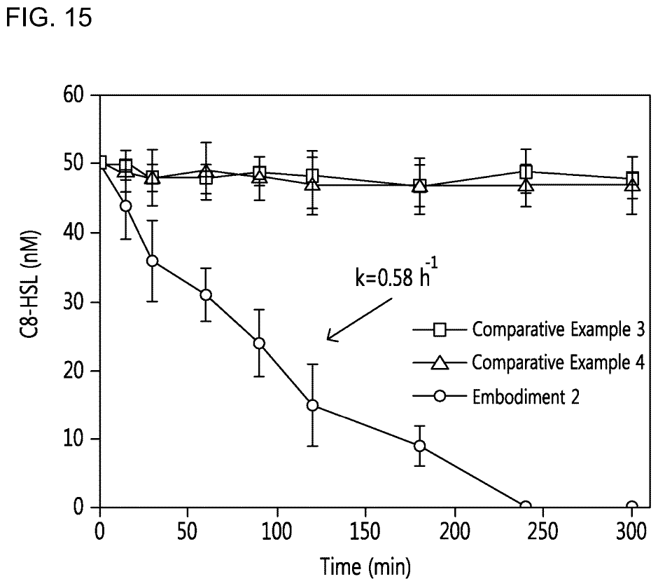

FIG. 15 illustrates a graph showing the degradation of C8-HSL in the bioassays of Embodiment 2, Comparative Example 3, and Comparative Example 4.

According to the results shown in FIG. 15, it can be seen that Comparative Examples 3 and 4 do not show the degradation of C8-HSL, while Embodiment 2 shows degradation with a constant of 0.58 h⁻¹.

According to the results shown in FIGS. 14 and 15, it can be seen that the degradation constant is proportional to the biovolume in FIG. 11. This can be seen to be proportional to the amount of quorum quenching microorganisms formed on the surface of the membrane.

According to the results shown in FIGS. 12 to 15, it can be seen that the quorum quenching microorganisms are alive and attached to the membrane filter.

### 2. Performance Analysis of Membrane Filter for Water and Wastewater Treatment

The performance of the membrane filters for water and wastewater treatment produced in Embodiments 1 and 2 and Comparative Examples 1 to 4 above was analyzed as a membrane filter, and the results are presented in FIGS. 16 to 22.

A PAO1 (P. aeruginosa) biofilm was formed on a membrane filter for water and wastewater treatment, and the results are shown in FIGS. 16 to 18.

(a) of FIG. 16 illustrates a CLSM image when forming a biofilm of PAO1 in Comparative Example 1, (b) illustrates a CLSM image for Comparative Example 2, and (c) illustrates an image for Embodiment 1.

(a) of FIG. 17 illustrates a CLSM image when forming a biofilm of PAO1 in Comparative Example 3, (b) illustrates a CLSM image in Comparative Example 4, and (c) illustrates a CLSM image in Embodiment 2.

FIGS. 16 and 17, green dots represent microorganisms, and red dots represent polysaccharides.

(a) of FIG. 18 illustrates a graph indicating the quantity of microorganisms from FIG. 16, and (b) illustrates a graph indicating the quantity of microorganisms from FIG. 17.

According to the results shown in FIGS. 16 to 18, it can be seen that a large number of microorganisms are formed in the membrane filters for water and wastewater treatment, whereas a very slight increase in microorganisms increased in Embodiments 1 and 2. In detail, there was a slight increase from 0.0044 μm³/μm² to 0.0067 μm³/μm² in Embodiment 1 and 0.0027 μm³/μm² to 0.0028 μm³/μm² in Embodiment 2. In other words, it can be seen that most of the green dots in Comparative Examples 1 to 4 are biofilms, while only quorum quenching microorganisms are mostly detected. This indicates that the quorum quenching microorganisms effectively inhibit biofilms such as PAO1. Particularly, it can be seen that no polysaccharides are detected in Embodiments 1 and 2.

The water permeabilities of Embodiments 1 and 2 and Comparative Examples 1 to 4 were measured, and the results are shown in FIG. 10.

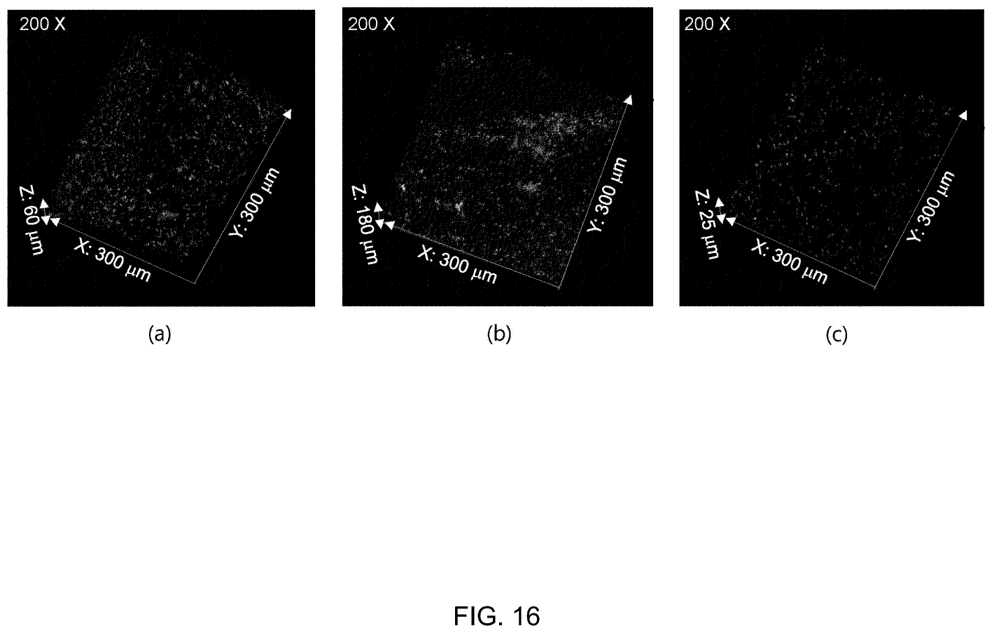

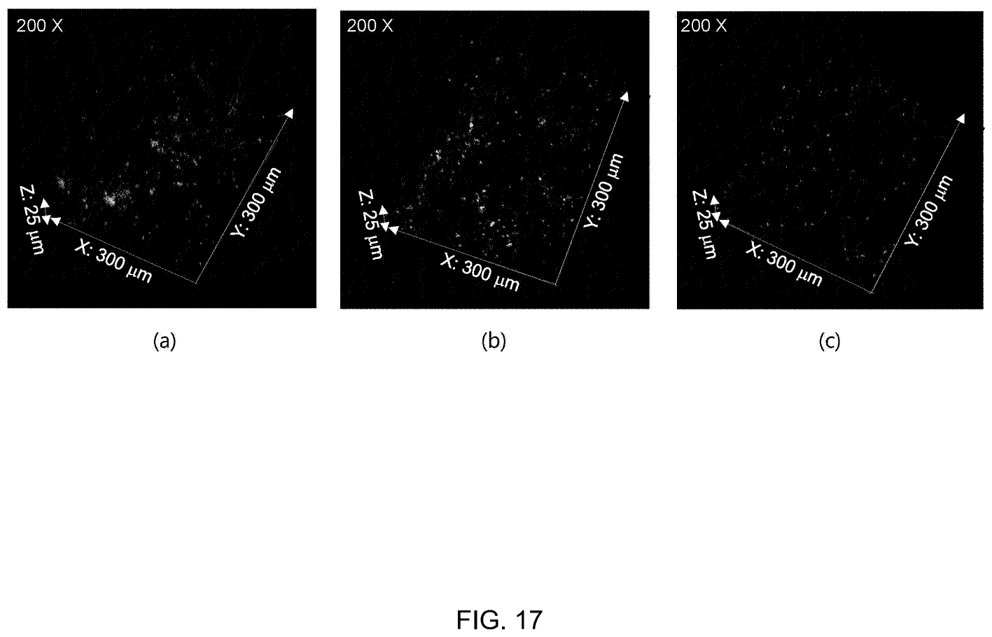

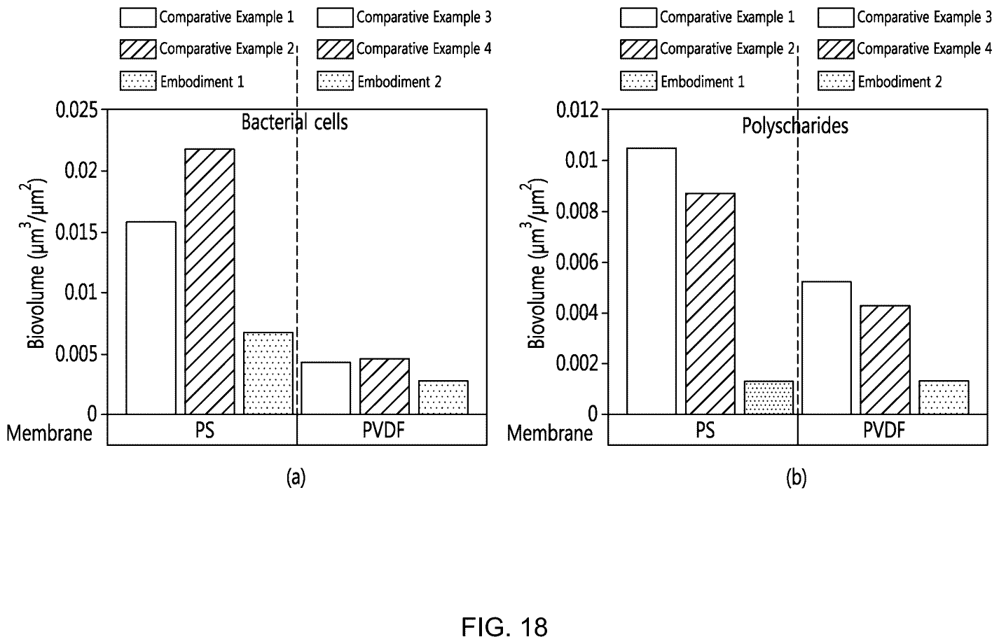

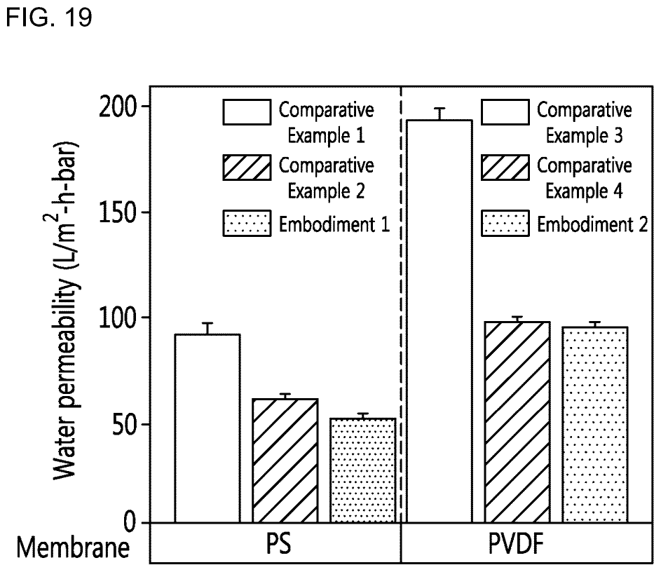

FIG. 19 illustrates a graph showing the water permeability of Embodiments 1 and 2 and Comparative Examples 1 to 4.

According to the results shown in FIG. 19, it can be seen that the water permeability of Embodiments 1 and 2, where quorum quenching microorganisms are formed, is relatively reduced compared to the comparative examples, but it is greater than 30 L/m²-h-bar, which is used as a membrane filter.

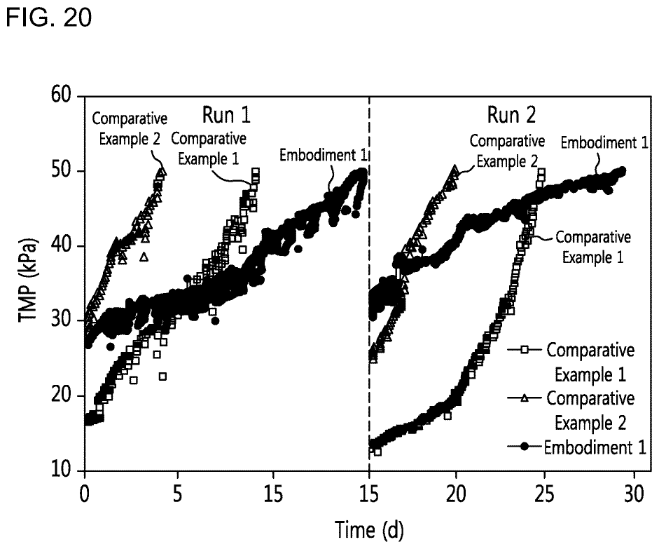

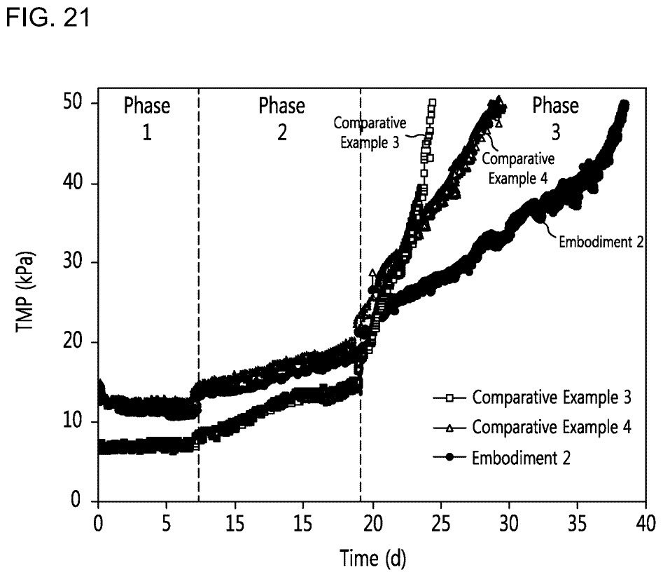

Transmembrane pressure (TMP), an indicator of membrane fouling that indicates the delayed degree of membrane fouling, was measured to confirm the quorum quenching effect of the membrane filter for water and wastewater treatment. TMP was recorded on the computer using digital pressure converters (ZSE 40F, SMC, Japan) and digital multimeters (M-3850D, Metex, Korea). TMP was measured and the results are shown in FIGS. 20 and 21.

FIG. 20 illustrates a graph of transmembrane pressure (TMP) for the membrane filters for water and wastewater treatment in Embodiment 1, Comparative Example 1, and Comparative Example 2 when a constant flux level of 15 L/m²-h is applied.

According to the results shown in FIG. 20, the initial TMP of Comparative Example 1 was the lowest, 16 kPa, whereas the initial TMP of Embodiment 1 and Comparative Example 2 was 26 kPa. This is compared to Comparative Example 1, the initial TMP was measured relatively high in Embodiment 1 and Comparative Example 2 because hydrophilic polymers and quorum quenching microorganisms were formed in Embodiment 1 and hydrophilic polymers were formed in Comparative Example 2. However, in terms of time to reach 50 kPa is the fastest, Comparative Example 2 is the fastest, taking around 4.5 days, followed by Comparative Example 1 at around 9.5 days, while Embodiment 1 is the longest, taking 14.6 days. This means that the quorum quenching microorganisms in the membrane filter for water and wastewater treatment of Embodiment 1 are appropriately formed, resulting in initially slightly lower water permeability and higher TMP compared to the general membrane filter, but it may delay membrane fouling, thereby improving the lifetime of the membrane filter.

FIG. 21 illustrates a graph of TMP for the membrane filters for water and wastewater treatment in Embodiment 2, Comparative Example 3, and Comparative Example 4 when a constant flux level of 15 L/m²-h, 20 L/m²-h, and 25 L/m²-h is applied.

According to the results shown in FIG. 21, it can be seen that there is no significant difference in the magnitude and variation of TMP during the application of flux levels at 15 L/m²-h and 20 L/m²-h. However, during the application of a flux level of 25 L/m²-h, it can be seen that TMP increases. Specifically, it can be seen that the TMP of Comparative Example 3 increases most rapidly, followed in order by Comparative Example 4 and Embodiment 2. In other words, in the membrane filter for water and wastewater treatment in Embodiment 2, quorum quenching microorganisms are appropriately formed, resulting in initially slightly lower water permeability and higher TMP compared to a general membrane filter; however, it may delay membrane fouling, thereby improving the lifetime of the membrane filter.

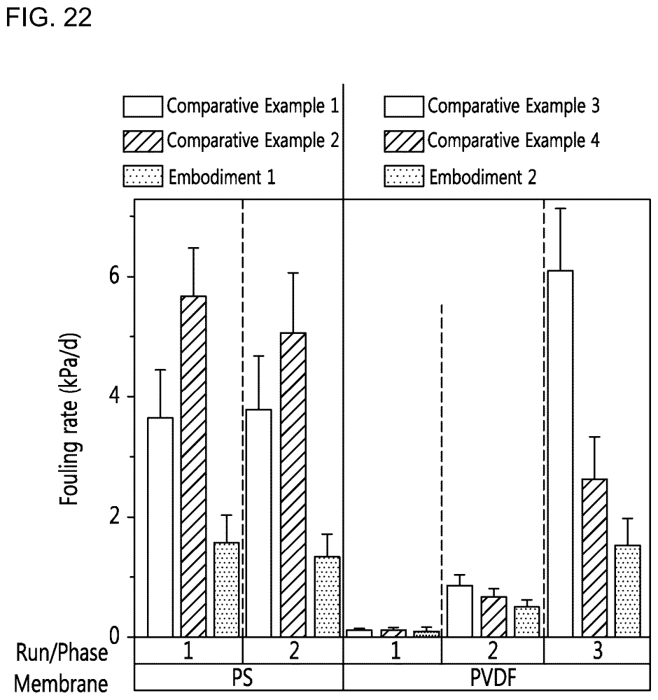

FIG. 22 illustrates a graph of the biofouling rates of Embodiments 1 and 2, and Comparative Examples 1 to 4.

According to the results shown in FIG. 22, it can be seen that in Embodiments 1 and 2, where quorum quenching microorganisms are attached, the fouling rate of the membrane filter is generally delayed by 57% to 67% compared to the commonly used membrane filters (Comparative Examples 1 and 3), and the fouling rate of the membrane filter is delayed by 30% to 57% compared to membrane filters where hydrophilic polymers are formed (Comparative Examples 2 and 4).

In conclusion, a membrane filter for water and wastewater treatment produced according to the present disclosure may have a lower water permeability compared to a commonly used membrane filter, but it is an appropriate value for use as a membrane filter for water and wastewater treatment, and the quorum quenching microorganisms are properly formed such that membrane fouling may be effectively delayed, thereby improving the lifetime of the membrane filter for water and wastewater treatment.

The description of the aforementioned present disclosure is for illustrative purposes, and those skilled in the art will understand that the present disclosure can be easily modified into other specific forms without changing its technical idea and essential features. Therefore, the embodiments described above should be understood in all aspects as illustrative and not restrictive. For example, each component described as unitary may be implemented in a distributed manner, and similarly, components described as distributed may also be implemented in a combined form.

The scope of the present disclosure is indicated by the claims to be described later rather than the detailed description above, and it should be interpreted that the meaning and scope of the claims and all changes or modifications derived from the equivalent concept are included in the scope of the present disclosure.

What is claimed is:

1. Membrane filter for water and wastewater treatment, comprising:
a membrane filter;
hydrophilic polymers formed on the membrane filter; and
quorum quenching microorganisms cross-linked with the membrane filter by the hydrophilic polymers.

2. The membrane filter for water and wastewater treatment of claim 1,
wherein the quorum quenching microorganisms comprise one or more selected from a group of Rhodococcus sp. BH4, Acinetobacter sp. DKY-1, Pseudomonas sp. Li4-2, Pseudomonas sp. 1A1, Pseudomonas sp. KS2, Pseudomonas sp. KS10, Bacillus methylotrophicus, Bacillus amyloliquefaciens, Candida albicans, Arthrobacter sp. MP1-2, Delftia sp. Le2-5, and Ralstonia sp. XJ12B.

3. The membrane filter for water and wastewater treatment of claim 1,
wherein the hydrophilic polymers comprise one or more selected from a group of polyvinyl alcohol, polyethylene glycol, polyacrylic acid, polyvidone, polyamine, chitosan, and alginic acid.

4. The membrane filter for water and wastewater treatment of claim 1, Wherein the surface of the membrane filter for water and wastewater treatment is coated with glycerol.

5. The membrane filter for water and wastewater treatment of claim 1,
a volume of the quorum quenching microorganism attached per unit surface area of the membrane filter for water and wastewater treatment is in a range of 0.001 μm³/μm² to 0.008 μm³/μm².

6. The membrane filter for water and wastewater treatment of claim 1,
wherein the water permeability of the membrane filter for water and wastewater treatment is in a range of 1 L/m²-h-bar to 600 L/m²-h-bar.

7. A method of producing a membrane filter for water and wastewater treatment, comprising:
impregnating a membrane filter in a solution containing quorum quenching microorganisms and hydrophilic polymers,
wherein the quorum quenching microorganisms are formed by being cross-linked with the membrane filter by the hydrophilic polymers.

8. The method of claim 7,
wherein the quorum quenching microorganisms comprise one or more selected from a group of Rhodococcus sp. BH4, Acinetobacter sp. DKY-1, Pseudomonas sp. Li4-2, Pseudomonas sp. 1A1, Pseudomonas sp. KS2, Pseudomonas sp. KS10, Bacillus methylotrophicus, Bacillus amyloliquefaciens, Candida albicans, Arthrobacter sp. MP1-2, Delftia sp. Le2-5, and Ralstonia sp. XJ12B.

9. The method of claim 7,
wherein the hydrophilic polymers comprise one or more selected from a group of polyvinyl alcohol, polyethylene glycol, polyacrylic acid, polyvidone, polyamine, chitosan, and alginic acid.

10. The method of claim 7,
wherein, with respect to 100 parts by weight of the solution, 0.1 to 5 parts by weight of the quorum quenching microorganism and 0.5 to 5 parts by weight of the hydrophilic polymer are included.

11. A method of controlling biological fouling, comprising:
using a membrane filter for water and wastewater treatment comprising:
a membrane filter;
hydrophilic polymers formed on the membrane filter; and
quorum quenching microorganisms cross-linked with the membrane filter by the hydrophilic polymers.

12. The method of claim 11,
wherein the method is applicable in field of membrane bioreactors, advanced wastewater treatment, and desalination.
